(19) United States
(12) Patent Application Publication
(10) Pub. No.: US 2009/0047642 A1
(43) Pub. Date: Feb. 19, 2009

(54) Reversible arithmetic teaching device

(76) Inventors: Albert Beatty, Colonia, NJ (US); Juanita Beatty, Brooklyn, NY (US)

Correspondence Address: Philip Kouyoumdjian;Feldman Law Group, P.C., 16th Floor, 12 East 41st Street, New York, NY, 10017, US

(21) Appl. No.: 11/891,688

(22) Filed: Aug. 13, 2007

(51) Int. Cl. G09B 19/02; G09B 3/00

(52) U.S. Cl. 434/191; 434/322

(57) ABSTRACT

A reversible arithmetic teaching device. In one embodiment, the device comprises a receptacle having on both sides a horizontal row of numbers with a corresponding arithmetic function below which is a window through which a reference number and arithmetically corresponding answers are visible.

A slidable card is inserted in the receptacle. The card has on its first side a vertical column of numbers and an array of rows of comprising corresponding numerical answers. One number at a time on each vertical column is displayed through the window. Indicating means permit the indication of a selected arithmetic relationship between any one number in the column of numbers located at one end of the slidable card and any one of the horizontal row of numbers on the receptacle such that, upon applying the arithmetic designation with respect to the two cooperating numbers, a corresponding answer is displayed through the window.

### FIELD OF INVENTION

The present invention relates to a reversible arithmetic teaching device for helping individuals learn how to perform mathematical functions such as addition, subtraction, multiplication and division. More particularly, the invention relates to an answer card having numbers on both sides of the card that is contained in a receptacle having corresponding numbers and designating a mathematical operation.

### BACKGROUND OF INVENTION

There is an unmet need for a lightweight, portable arithmetic teaching device for helping individuals, especially children, understand and-memorize basic mathematical functions.

Currently, there are mathematical tools that are used to educate children in the areas of addition, subtraction, and multiplication. Most of these tools are boards, rods, plates, tables or cards bearing limited data made of several moving parts, and are made of solid and inflexible materials such as wood, thick plastic, or metal; or are made of fragile materials, such as paper or celluloid. None of these tools are reversible in nature, i.e., the prior art does not have a dual function that helps the user of the arithmetic tool both memorize mathematical operations, and allows the user to quiz him- or herself on the mathematical function displayed on the card.

To grasp basic arithmetic functions, a student must first have a desire to use a teaching device. Such an device must be easy to use and understand, and readily accessible. If a child is able to utilize such a tool during his or her formative years, he or she will have laid a solid foundation for understanding higher-level math in the future.

Studies in the U.S. have shown that children in America have fallen behind children in many other countries across the world in the areas of math and science. A new learning device is necessary to stimulate enthusiasm in young children to learn basic math.

Information relevant to attempts to address these problems can be found in U.S. Pat. No. 565,797 ('797); U.S. Pat. No. 1,666,337 ('337); U.S. Pat. No. 4,445,865 ('865); U.S. Pat. No. 5,820,382 ('382); and Pub. No.: U.S. 2004/0086836 A1. However, each one of these references suffers from one or more of the following disadvantages: '797, '865, '382 and U.S. 2004/0086836 include more than one moving part, rendering them more difficult to use and understand than the present invention; they are larger, heavier, or more rigid, thus rendering them more unwieldy as compared to the present invention; and they contain more visible information, and are, therefore, less informationally streamlined than the present invention. As to '337, it is more fragile and contains considerably less information. Moreover, the present invention performs a dual function, while the references cited do not.

For the foregoing reasons, there is a need for a simple, inexpensive, lightweight, accessible arithmetic instructional device that can teach individuals rudimentary math functions quickly and easily.

### SUMMARY OF INVENTION

The present invention is directed to a reversible arithmetic teaching device that satisfies these needs. A reversible arithmetic teaching device having features of the present invention comprises an envelope-like receptacle, the receptacle having two horizontal windows on each side of the receptacle located below the top portion of the receptacle, as well as an aperture on both sides that is adjacent to the window. A plurality of consecutive numbers is printed horizontally between the top of the envelope and the window. An answer card having a tab protruding outwardly from the top of the receptacle is contained within the receptacle. Each side of the card has a plurality of intersecting rows and columns of consecutive numbers. On one side of the card, one of the pluralities of rows appears through the window at any one time. A reference number at one end of the row is visible through the aperture and corresponds with a number (“numerical indicia”) on the envelope, whereby a mathematical operation is performed in accordance with an arithmetic indicator. The numerical answer to this operation is located directly below the numerical indicia on the receptacle. The row of answers extends horizontally from the reference number located on either the left end or the right end of the answer card.

The opposite side of the receptacle contains the same information as the first side. The opposite side of answer card, however, displays the reference number through the aperture on the reverse side of the receptacle, but does not show any corresponding answers in the window following the reference number. The user of the arithmetic teaching device must perform a mathematical operation, for example, by adding the reference number on the card to the numerical indicia on the receptacle, and determining the answer. The corresponding answers are offset by one row on the card. Thus, the user may then verify the answer by simply sliding the card up one row, thus revealing the corresponding answer.

A plurality of functions can be performed by sliding the card up or down, thereby revealing a plurality of arithmetic problems and their corresponding answers.

Indicating means is provided to indicate on the envelope a reference number and an arithmetic answer wherein a reference number at one end of the row is visible through the aperture, while either simultaneously indicating directly below the numerical indicia on the envelope the answer to that problem, or, alternatively, displaying the answers that are offset one row relative to the reference number. Indicating means is defined to include cut-outs of the receptacle, thus generating a window and aperture, a transparent material covering the cut-outs, or other suitable material that that allows the related elements (reference number, numerical indicia and answer) to be readily discernable at a glance by manipulating the tab on the slidable card.

For the mathematical operation of addition, the reference number is the augend, the numerical indicia is the addend; and the arithmetic answer is the sum; in subtraction, the reference number is the minuend, the numerical indicia on the envelope is the subtrahend, and the answer is the difference.

If the mathematical operation is multiplication, the reference number is the multiplicand, the numerical indicia is the multiplier and the answer is the product.

If the mathematical function is division, the reference number is the dividend, the numerical indicia is the divisor, and the answer is the quotient.

### DRAWINGS

These and other features, aspects and advantages of the present invention will become better understood with reference to the following description, appended claims and accompanying drawings where:

FIG. 1 is a perspective view of a reversible arithmetic teaching device showing one side of the device.

FIG. 1a is a perspective view of a reversible arithmetic teaching device showing the other side of the device.

FIG. 2 is an elevational view of one side of a reversible arithmetic teaching device with parts separated.

FIG. 2a is an elevational view of the other side of a reversible arithmetic teaching device with parts separated.

FIG. 3 is an elevational view in partial cutaway of one side of a reversible arithmetic teaching device.

FIG. 3a is an elevational view in partial cutaway of the other side of a reversible arithmetic teaching device.

FIG. 4 is an elevational view in partial cutaway of another embodiment (subtraction) of one side of a reversible arithmetic teaching device.

FIG. 4a is an elevational view in partial cutaway of the same embodiment as shown in FIG. 4 (subtraction) of the other side of a reversible arithmetic teaching device.

FIG. 5 is an elevational view in partial cutaway of another embodiment (multiplication) of one side of a reversible arithmetic teaching device.

FIG. 5a is an elevational view in partial cutaway of the same embodiment as shown in FIG. 5 (multiplication) of the other side of a reversible arithmetic teaching device.

### DETAILED DESCRIPTION

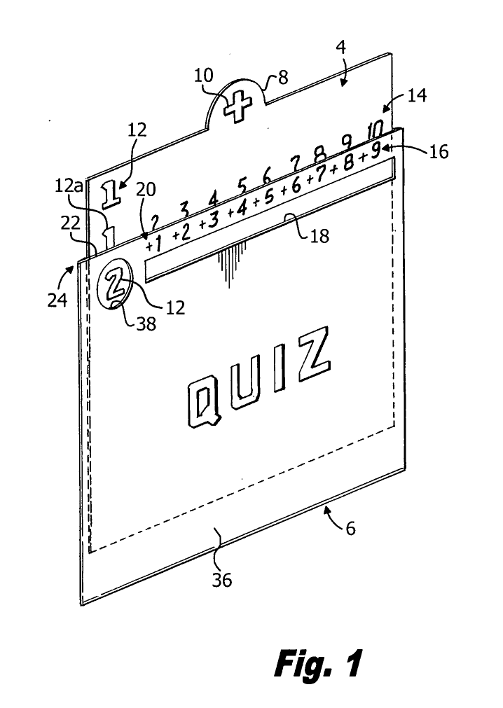

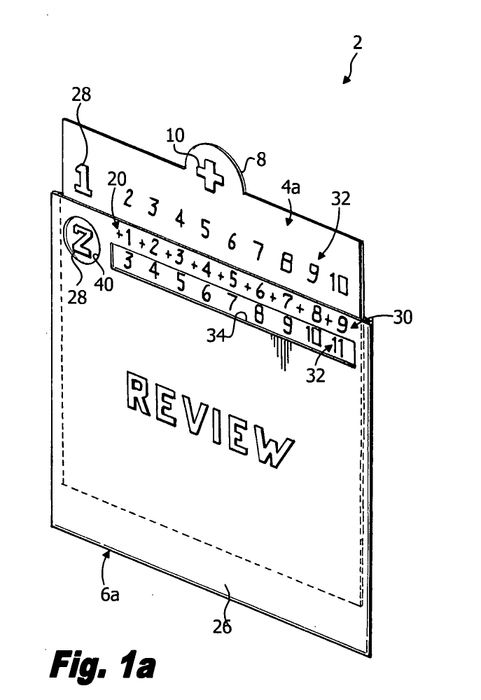

As shown in FIG. 1 and 1a, respectively, a reversible arithmetic teaching device 2 comprises a problem solving side 36, a memorization side 26, an answer card 4, and a receptacle 6, which accepts answer card 4.

As shown in FIG. 1, answer card 4 includes tab 8 that designates a mathematical operation 10.

As shown in FIGS. 1, 2, 4, 5, 6, and 7, answer card 4 is slidably mounted in an open-ended receptacle 6 having a proximal opening 22 at proximal end 24, a window 18, and an aperture 38 on problem solving side 36.

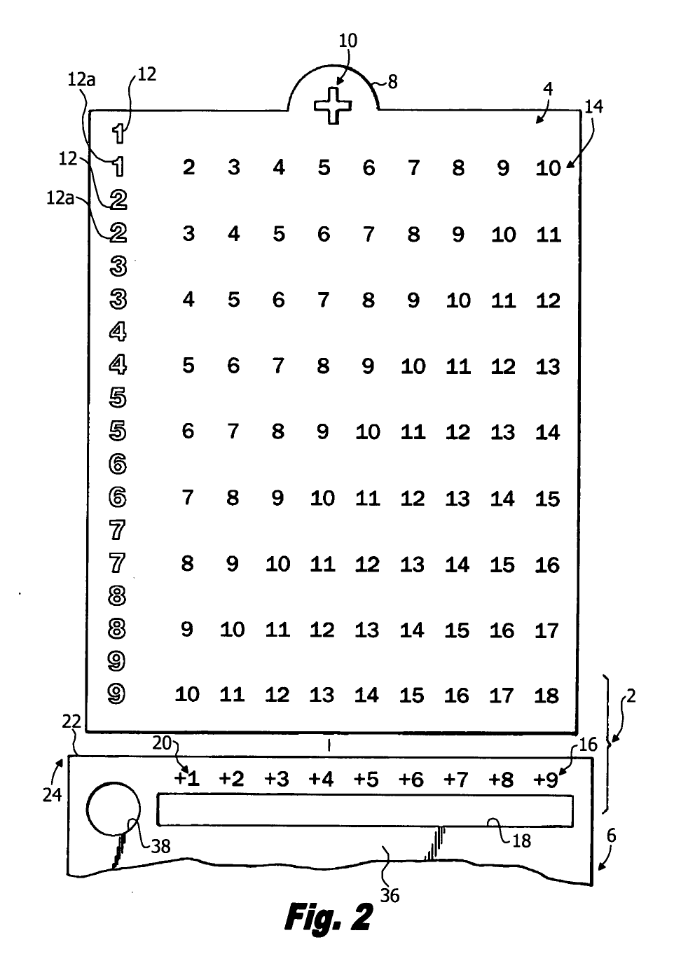

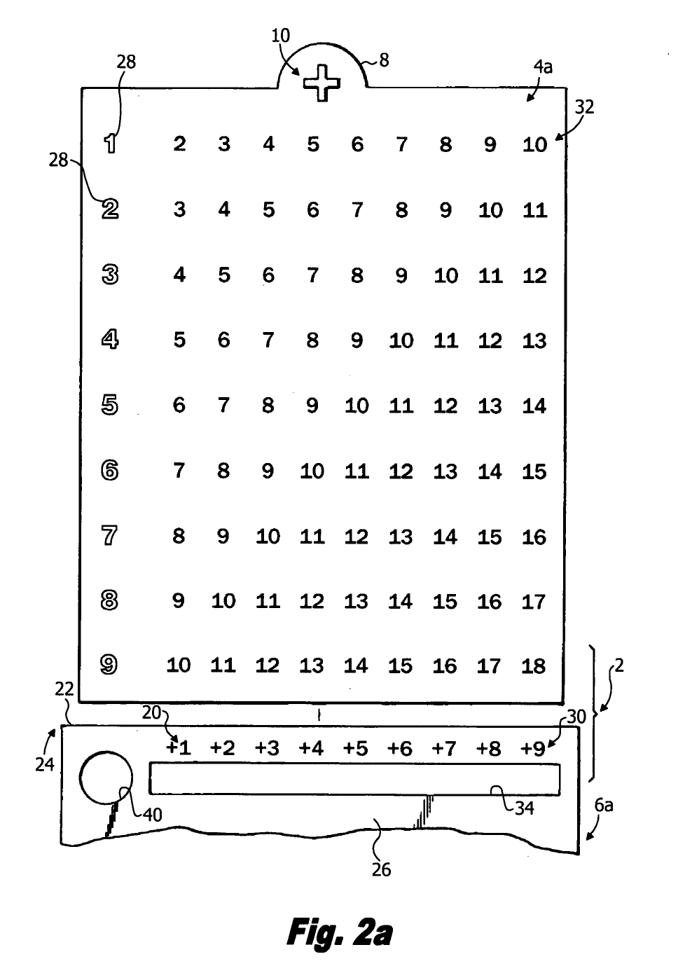

As shown in FIG. 2, answer card 4 further includes a vertical column consisting of consecutive reference numbers 12 and 12a and an array of rows and columns comprising arithmetic answers 14.

Receptacle 6 includes numerical indicia 16, a window 18 through which arithmetic answers 14 are visible, and aperture 38 through which reference numbers 12 are visible. In the preferred embodiment, an arithmetic indicator 20, corresponding with the mathematical function 10, is assigned to each numerical indicia 16 to assist in solving arithmetic problems. Reference numbers 12 correspond with numerical indicia 16 displayed on receptacle 6.

The columns and rows on answer card 4 are arrayed in such a way that each reference number 12 occupies its own row and has no ensuing arithmetic answers 14 visible through window 18 located on receptacle 6. Rather, arithmetic answers 14 corresponding to the reference numbers 12 and numerical indicia 16 are oriented in such a way that arithmetic answers 14 are offset by one row or level below reference numbers 12, and are revealed in window 18 by indicating means using tab 8 and sliding card 4 longitudinally upward through proximal opening 22, thereby displaying in aperture 38 the same reference number 12a as the reference number 12 directly above it, and displaying in window 18 the next horizontal row comprising the corresponding arithmetic answers 14.

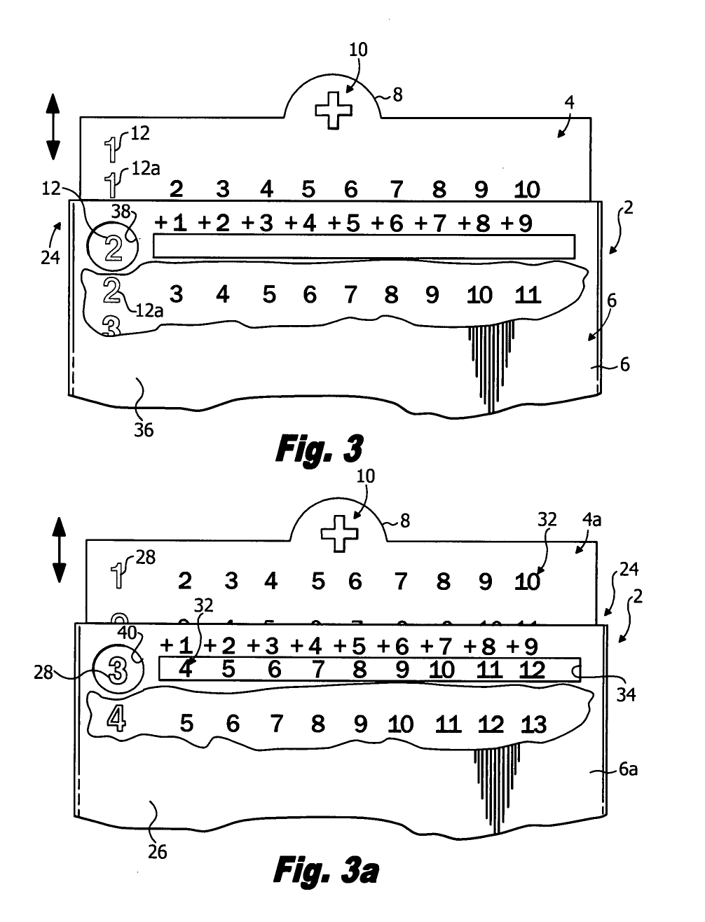

As shown in FIG. 3, the first arithmetic answer 14 on answer card 4 is positioned immediately adjacent to reference number 12a, with successive arithmetic answers 14 extending linearly relative to the first arithmetic answer 14.

Thus, as in FIG. 3, arithmetic answer 14 is not revealed until answer card 4 is pulled longitudinally through proximal opening 22, preferably using tab 8.

In this embodiment, the user learns a mathematical operation by determining the arithmetic answer 14 before it is revealed in window 18. This allows the user to quiz him- or herself by first ascertaining the answer, then determining if it is correct.

As shown in FIG. 1a, arithmetic teaching device 2 contains further data on memorization side 26, wherein each reference number 28 cooperates with numerical indicia 30.

As shown in FIG. 2a, answer card 4a is the opposing side of answer card 4, and receptacle 6a is the opposing side of receptacle 6. Receptacle 6a preferably contains the same information as receptacle 6.

For each reference number 28 on answer card 4a, there is a corresponding row of arithmetic answers 32 extending linearly from reference number 28. Thus, as shown in FIG. 3a, aperture 40 must always display reference number 28, and window 34 must always display corresponding arithmetic answers 32 adjacent to reference number 28.

As shown in FIG. 3a, a horizontal row of corresponding arithmetic answers 32 is visible through window 34 and is positioned immediately adjacent to reference number 28, which is visible through aperture 40, with successive arithmetic answers 32 extending linearly relative to the first arithmetic answer 32.

In the preferred use of reversible arithmetic teaching device 2, memorization side 26 is first very carefully analyzed independent of problem solving side 36, the memorization side 26 being preferably provided with cooperating reference numbers 28 and numerical indicia 30, wherein any or all mathematical operations are studied for committing to memory the corresponding answers 32.

When the mathematical operation has been partially or completely mastered, the arithmetic teaching device 2 is turned around and the problem solving side 36 is utilized to test the user's memory and/or understanding of the mathematical operation. By this test, the user is made clearly conscious of the problems he or she knows and those he or she does not know. When the test reveals that the user does not know the answer to a specific arithmetic operation, the answer card 4 is raised one level so as to disclose together the same specific operation and corresponding answer to assist in committing to memory the operation effectively and permanently. After having seen the relationship between reference number 12 and numerical indicia 16 with the corresponding arithmetic answer 14, the user easily and quickly lowers the answer card 4 one level, whereupon he or she is able to visualize the arithmetic answer 4 in the spot where it was just previously seen.

By the use of this device, mathematical operations can be first studied or memorized by utilizing memorization side 26, which simply requires moving the answer card 4a up or down. Moreover, the user may test his or her understanding with minimal effort by turning the device 2 around and utilizing the problem solving side 36. After attempting to solve a mathematical operation, the answers can be seen when needed with minimal effort by simply raising and lowering the answer card.

Because reversible arithmetic teaching device 2 comprises one receptacle and one card, reference henceforth to card 4 and receptacle 6 also apply to card 4a and receptacle 6a, respectively.

In the form of construction as shown in FIGS. 1, 2, 4, 5, 6, and 7, card 4 is preferably rectangular in shape, and, in one embodiment, is 4½ inches wide by 3 inches long. Card 4 is slightly shorter than the length of the aperture 22 of receptacle 6 so that card 4 can be readily manipulated for longitudinal movement through receptacle 6 for bringing the different sets of related elements, which are discussed above, successively into view through aperture 38 and window 18, both of which are a width sufficient to display a horizontal row comprising the reference number and as many arithmetic answers 14 as required by the corresponding numerical indicia 16. In this embodiment, window 18 is approximately 4½ inches long and about ½ inch wide, and aperture 38 is circular and is ½ inch wide by ½ inch long. The envelope 6 is also rectangular, and, in one preferred embodiment, is 6 inches wide by 4 inches long. Aperture 22 is preferably 4¾ inches wide.

In another preferred embodiment, window 18 is about 80% of the width of receptacle 6, and 10% of the length of receptacle 6. Aperture 38 is about 10% of the width of receptacle 6 and about 10% of the length of receptacle 6. Slidable card 4 is about 95% of the width of receptacle 6 and is about 100% of the length of receptacle 6. Tab 8 is about 10% of the length and 10% of the width of card 4 and is preferably located in the center of card 4.

An alternative embodiment for the manufacture of the card 4 and the envelope 6 is thin cardboard, index card paper, or any other suitable material having a coefficient of friction that allows the envelope 6 to easily receive the card 4, and allows the card 4 to slide easily within envelope 6, but does not allow the card 4 to fall out of the envelope 6 if the arithmetic device 2 is turned upside down.

Other embodiments of this invention may disclose different dimensions of the answer card 4 and the envelope 6, but card 4 must be of sufficient width to be inserted though an aperture 22 located at the upper edge of the envelope 6 such that it slides within the envelope 6, whereby the reference number 12 and arithmetic answers correspond with numerical indicia 16.

FIG. 1 shows the problem solving side 36 of reversible arithmetic teaching device 2. As shown in FIG. 1, the reference number 12 is added to any one numerical indicia 16 resulting in an arithmetic answer 14 that is visible through the window 18 when tab 8 is pulled one row up. Answer 14 is now located directly below the numerical indicia 16. For example, if the number “two” is the reference number 12 and is added to a numerical indicia 16 number “four,” the arithmetic answer 14 is the sum of the reference number 12 and the numerical indicia 16, in this case “six,” which, when card 4 is slid upward one row or level, is located directly below the addend “four,” and is visible through the window 18. By pulling tab 8 upward one row, reference number 12a (number “two”) is displayed through aperture 38.

FIG. 1a is a perspective view of the memorization side 26 of arithmetic teaching device 2. In the preferred embodiment, the answer card 4 has been repositioned by pulling the tab 8 longitudinally such that the reference number 28 is augend number “two” and is visible through aperture 40. The augend is added to a numerical indicia 30, for example, the addend “three,” which reveals the sum “five,” which is located directly below the numerical indicia “three” and is visible through the window 34. This sum “five” is the corresponding arithmetic answer 32.

Other embodiments of this invention may disclose an unlimited number of reference numbers, numerical indicia and corresponding arithmetic answers.

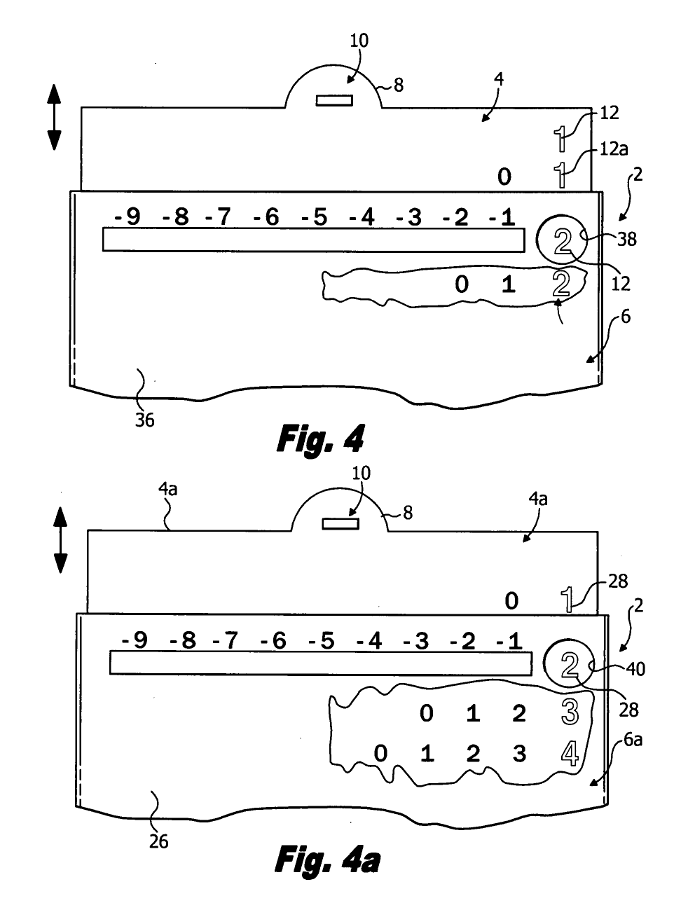

FIGS. 4 and 4a show an alternative embodiment of the arithmetic device 2, whereby reference numbers 12 and 12a are located either on the right side of the answer card 4. As shown in FIGS. 4 and 4a, if the mathematical function of the arithmetic device 2 is subtraction, the cooperative relationships among the reference numbers 12, numerical indices 16 and arithmetic answers 14 are preferably inverted relative to the arithmetic device 2 having addition as its mathematical function.

Accordingly, the reference numbers 12 are preferably positioned on the right side of the card 4, whereby aperture 38 displaying reference number 12 is oriented at the right end of the window 18. In this preferred embodiment, the reference number 12 is the minuend, the corresponding numerical indicia 16 is the subtrahend and the arithmetical answer 14 is the difference. The arithmetic indicator 20 and the mathematical function 10 are the minus sign, “−.”

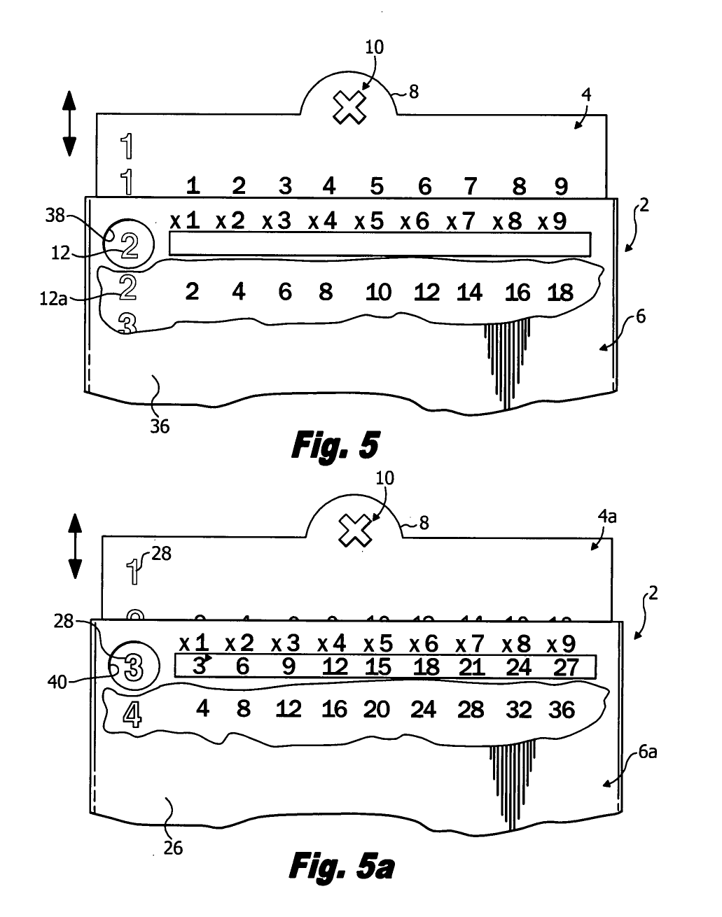

FIGS. 5 and 5a preferably have the same numerical orientation as FIGS. 1-3a, and have multiplication as the mathematical operation, whereby arithmetic indicator 20 and mathematical function 10 are preferably represented by the multiplication symbol “×.” The reference number 12 is the multiplicand, the numerical indicia 16 is the multiplier, and the arithmetic answer 14 is the product.

One of ordinary skill in the art would recognize that various other mathematical functions may also be utilized on the arithmetic teaching device 2, including but not limited to algorithms, trigonometric functions, calculus, and differential equations.

In the various embodiments of the present invention, the unique concept is an accessible and lightweight arithmetic teaching device that contains only two parts, and that can be manufactured inexpensively. The device is lightweight and accessible because it is preferably the size of an index card.

The answer card 4 can be made of a material such as a thin, flexible, smooth plastic, plastic coated material, cardboard or any similar product having a low coefficient of friction. The receptacle 6 can be made of the same material as the card 4. For that reason, card 4 and receptacle 6 can be cut from a thin sheet of plastic, cardboard or similar product. The invention is also simply designed and, therefore, easy to manipulate in that it has only one moving part, i.e., the answer card.

Although the present invention has been described in considerable detail with reference to certain preferred versions thereof, other versions are possible. For example, the arithmetic teaching device may also teach other mathematical operations, including but not limited to: logic operations, trigonometric operations, amplitude functions, random functions, opcode equivalents of functions, exponentiation, factorials, linear equations, modulo division, matrix operations, permutations, combinations, differentiations, logarithms, gamma functions, hypergeometric functions, and a variety of other functions not listed herein. Therefore, the spirit and scope of the appended claims should not be limited to the description of the preferred versions contained herein.

What is claimed is:

1. An arithmetic teaching device, said device comprising:
(a) a card comprising:
(i) a tab denoting a mathematical operation;
(ii) a column;
i. said column comprising reference numbers; and
(iii) an array of rows comprising arithmetic answers, whereby each row of arithmetic answers corresponds to one reference number and is located one level below said reference number;
(b) a receptacle comprising:
(i) an opening;
(ii) a window comprising:
a. indicating means for indicating said reference number and said arithmetic answers; and
(iii) numerical indicia.

2. The arithmetic teaching device of claim 1 whereby said card is slidably mounted with respect to said receptacle.

3. The arithmetic teaching device of claim 2 whereby said reference numbers are individually visible through said window and relate to said numerical indicia in accordance with said mathematical operation.

4. The arithmetic teaching device of claim 3 whereby said arithmetic answers correspond with said relationship between said reference numbers and said numerical indicia and are displayed in said window using said indicating means.

5. The arithmetic teaching device of claim 1, said device further comprising:
(a) said card having an opposing side comprising:
(i) said tab having an opposing side denoting a mathematical operation;
(ii) a column comprising reference numbers; and
(iii) an array of rows comprising arithmetic answers, whereby each row corresponds to one reference number and is located adjacent to said reference number.
(b) said receptacle having an opposing side comprising:
(i) said opening;
(ii) a window comprising:
a. indicating means for indicating reference numbers and arithmetic answers; and
(iii) numerical indicia.

6. The arithmetic teaching device of claim 5 whereby said card is slidably mounted with respect to said receptacle.

7. The arithmetic teaching device of claim 6 whereby said reference numbers are individually visible through said window and relate to said numerical indicia in accordance with said mathematical operation.

8. The arithmetic teaching device of claim 7 whereby said arithmetic answers correspond with said relationship between said reference numbers and said numerical indicia and are displayed in said window using said indicating means.
